(19) United States
(12) Patent Application Publication
(10) Pub. No.: US 2009/0240836 A1
(43) Pub. Date: Sep. 24, 2009

(54) SUPPORT APPARATUS, DESIGN SUPPORT METHOD, AND DESIGN SUPPORT PROGRAM

(75) Inventors: Miki TAKAGI, Kawasaki (JP); Takeo Nakamura, Kawasaki (JP); Toshiya Yamazaki, Kawasaki (JP)

Correspondence Address: Fujitsu Patent Center;C/O CPA Global, P.O. Box 52050, Minneapolis, MN, 55402, US

(73) Assignee: FUJITSU LIMITED, Kawasaki (JP)

(21) Appl. No.: 12/406,325

(22) Filed: Mar. 18, 2009

(30) Foreign Application Priority Data
Mar. 18, 2008 (JP) 2008-068655

(51) Int. Cl. G06F 15/173; G06F 15/16

(52) U.S. Cl. 709/245; 709/250

(57) ABSTRACT

The configuration data obtaining unit obtains a network configuration data, and the actual-apparatus collection result data obtaining unit obtains an actual-apparatus collection result data. Then, the comparing unit compares a network address in the network configuration data corresponding to a network apparatus with a network address in the actual-apparatus collection result data corresponding to the network apparatus, and determines whether the network address is normally set to the network apparatus based on the comparison result.

### CROSS-REFERENCE TO RELATED APPLICATIONS

This application claims the conventional priority based on Japanese Application No. 2008-068655, filed on Mar. 18, 2008, the disclosures of which are incorporated herein by reference.

### BACKGROUND OF THE INVENTION

1. Field of the Invention

The present invention relates to a design support apparatus, a design support method, and a design support program. In particular, the present invention relates to a design support apparatus, a design support method, and a design support program which determine whether a network address is normally set to a network apparatus or not, based on the result of comparing a network configuration data including a network address of a network apparatus with an actual-apparatus collection result data which is collected from network environment.

2. Description of the Related Art

There is proposed a network device controlling apparatus which inputs an IP address to be set to a network device, compares the inputted IP address with IP addresses of network devices operating on a network, and sets the IP address to be set to the network device based on the comparison result (refer to Japanese Patent Laid-Open No. 11-282644).

A person who draws a block diagram of a network system is generally different from a person who actually constructs a network. Since there is presently unavailable unified tool, format and rule for drawing the block diagram of a network system, the block diagram is often different depending on a person who draws the block diagram of the network system. For this reason, the block diagram is often not updated to the latest information because of difficulty in maintenance work.

On the other hand, a person who constructs a network performs work according to the block diagram of a network. When the network is reconstructed, if the block diagram of a network is not updated, a network construction cannot be checked in advance based on an updated block diagram. This causes a problem that the network construction needs checking by an ineffective method for testing operation after the network has actually been reconstructed. Therefore, until now it has been difficult to determine whether a network address (for example, IP address) is normally set to a network apparatus in the network system based on the block diagram of a network.

For example, even if the network address of the network apparatus in the block diagram of a network does not coincide with the network address of an actual network apparatus in the constructed network environment, when the network address of an actual network apparatus is unique, the actual network apparatus operates without any problem. However, until now, it has not been automatically determined whether the actual network apparatus operates without any problem even if the network address of the network apparatus in the block diagram of a network does not coincide with the network address of an actual network apparatus in the constructed network environment.

### SUMMARY OF THE INVENTION

It is an object of the present invention to provide a design support apparatus which automatically determines whether a network address is normally set to a network apparatus based on the result of comparing a network configuration data including a network address of a network apparatus with an actual-apparatus collection result data which is collected from network environment.

It is another object of the present invention to provide a design support method for automatically determining whether a network address is normally set to a network apparatus based on the result of comparing a network configuration data including a network address of a network apparatus with an actual-apparatus collection result data which is collected from network environment.

It is still another object of the present invention to provide a design support program for automatically determining whether a network address is normally set to a network apparatus based on the result of comparing a network configuration data including a network address of a network apparatus with an actual-apparatus collection result data which is collected from network environment.

### SUMMARY OF THE INVENTION

The design support apparatus comprises a first obtaining unit obtaining a network configuration data in which a plurality of network apparatuses and network address allocated to each of the network apparatuses are recorded, a second obtaining unit obtaining an actual-apparatus collection result data collected from network environment constructed based on the network configuration data, a comparing unit comparing a network address in the network configuration data corresponding to a network apparatus with a network address in the actual-apparatus collection result data corresponding to the network apparatus, and determining that the network address is normally set to the network apparatus when the network address in the network configuration data coincides with the network address in the actual-apparatus collection result data, and a first uniqueness determination unit determining, when the comparing unit determines that the network address in the network configuration data corresponding to the network apparatus does not coincide with the network address in the actual-apparatus collection result data corresponding to the network apparatus, whether the network address in the actual-apparatus collection result data corresponding to the network apparatus is unique in the actual-apparatus collection result data, and determining that the network address is normally set to the network apparatus when the network address is unique in the actual-apparatus collection result data.

Preferably, the design support apparatus further comprises a second uniqueness determination unit determining, when the first uniqueness determination unit determines that the network address is not unique in the actual-apparatus collection result data, whether the network address in the actual-apparatus collection result data corresponding to the network apparatus is unique in a network to which the network apparatus in the actual-apparatus collection result data belongs, and determining that the network address is normally set to the network apparatus when the network address is unique in the network.

Preferably, the design support apparatus further comprises a virtual address determination unit determining, when the second uniqueness determination unit determines that the network address is not unique in the network, whether the network address is a virtual address, and determining that the network address is normally set to the network apparatus when the network address is a virtual address.

The design support method comprises a first obtaining step of obtaining a network configuration data in which a plurality of network apparatuses and network address allocated to each of the network apparatuses are recorded, a second obtaining step of obtaining an actual-apparatus collection result data collected from network environment constructed based on the network configuration data, a comparing step of comparing a network address in the network configuration data corresponding to a network apparatus with a network address in the actual-apparatus collection result data corresponding to the network apparatus, and determining that the network address is normally set to the network apparatus when the network address in the network configuration data coincides with the network address in the actual-apparatus collection result data, and a first uniqueness determination step of determining, when the comparing step determines that the network address in the network configuration data corresponding to the network apparatus does not coincide with the network address in the actual-apparatus collection result data corresponding to the network apparatus, whether the network address in the actual-apparatus collection result data corresponding to the network apparatus is unique in the actual-apparatus collection result data, and determining that the network address is normally set to the network apparatus when the network address is unique in the actual-apparatus collection result data.

Preferably, the design support method further comprises a second uniqueness determination step of determining whether the network address in the actual-apparatus collection result data corresponding to the network apparatus is unique in a network to which the network apparatus in the actual-apparatus collection result data belongs when the first uniqueness determination step determines that the network address is not unique in the actual-apparatus collection result data, and determining that the network address is normally set to the network apparatus when the network address is unique in the network.

Preferably, the design support method further comprises a virtual address determination step of determining, when the second uniqueness determination step determines that the network address is not unique in the network, whether the network address is a virtual address, and determining that the network address is normally set to the network apparatus when the network address is a virtual address.

The design support program causes a computer to execute a first obtaining process of obtaining a network configuration data in which a plurality of network apparatuses and network address allocated to each of the network apparatuses are recorded, a second obtaining process of obtaining an actual-apparatus collection result data collected from network environment constructed based on the network configuration data, a comparing process of comparing a network address in the network configuration data corresponding to a network apparatus with a network address in the actual-apparatus collection result data corresponding to the network apparatus, and determining that the network address is normally set to the network apparatus when the network address in the network configuration data coincides with the network address in the actual-apparatus collection result data, and a first uniqueness determination process of determining whether the network address in the actual-apparatus collection result data corresponding to the network apparatus is unique in the actual-apparatus collection result data when the comparing process determines that the network address in the network configuration data corresponding to the network apparatus does not coincide with the network address in the actual-apparatus collection result data corresponding to the network apparatus, and determining that the network address is normally set to the network apparatus when the network address is unique in the actual-apparatus collection result data.

Preferably, the design support program causes a computer to execute a second uniqueness determination process of determining, when the first uniqueness determination process determines that the network address is not unique in the actual-apparatus collection result data, whether the network address in the actual-apparatus collection result data corresponding to the network apparatus is unique in a network to which the network apparatus in the actual-apparatus collection result data belongs, and determining that the network address is normally set to the network apparatus when the network address is unique in the network.

Preferably, the design support program causes a computer to execute a virtual address determination process of determining, when the second uniqueness determination process determines that the network address is not unique in the network, whether the network address is a virtual address, and determining that the network address is normally set to the network apparatus when the network address is a virtual address.

According to the design support apparatus, the design support method and the design support program, a determination can be automatically made as to whether a network address is normally set to a network apparatus, based on the result of comparing the network address in a network configuration data corresponding to the network apparatus with a network address in an actual-apparatus collection result data corresponding to the network apparatus. According to the design support apparatus, the design support method and the design support program, a determination can be made as to whether the setting of a network address to the actual apparatus causes a problem in terms of the operation of the actual apparatus, based on the result of determining whether the network address set to the actual network apparatus is unique in an actual-apparatus collection result data.

Furthermore, according to the design support apparatus, the design support method and the design support program, a determination can be made as to whether the setting of a network address to the actual apparatus causes a problem in terms of the operation of the actual apparatus, based on the result of determining whether the network address set to the actual network apparatus is unique in the network which is the same as the network to which the network apparatus belongs.

Still furthermore, according to the design support apparatus, the design support method and the design support program, a determination can be made as to whether the setting of a network address to the actual apparatus causes a problem in terms of the operation of the actual apparatus, based on the result of determining whether the network address set to the actual network apparatus is a virtual address.

Additional objects and advantages of the invention will be set forth in part in the description which follows and, in part will be obvious from the description, or may be learned by practice of the present invention. The object and advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

FIG. 1 is a diagram showing an example of a structure of a design support apparatus of the present embodiment.

FIG. 2 is a diagram showing an example of a configuration data.

FIG. 3 is a diagram showing an example of an actual-apparatus collection result data.

FIGS. 4 and 5 show flow chart of a design support process in a first embodiment of the present invention.

FIG. 6 is a diagram showing an example displayed by a display unit.

FIG. 7 is a diagram showing an example of a configuration data.

FIG. 8 is a diagram showing an example of the actual-apparatus collection result data.

FIGS. 9A and 9B are diagrams showing an example of determination parameters.

FIGS. 10 and 11 show flow chart showing a design support process in the second embodiment of the present invention.

FIG. 12 is a diagram showing an example displayed by the display unit.

FIG. 13A shows a block diagram before correction. FIG. 13B shows the block diagram after the correction.

FIG. 14 is a diagram showing an example of the configuration data.

FIG. 15 is a diagram showing an example of the actual-apparatus collection result data.

FIG. 16 is a diagram showing an example of determination parameters.

FIGS. 17 and 18 show flow chart of a design support process in a third embodiment of the present invention.

FIG. 19 is a diagram showing an example displayed by the display unit.

### DETAILED DESCRIPTION OF THE PREFERRED EMBODIMENTS

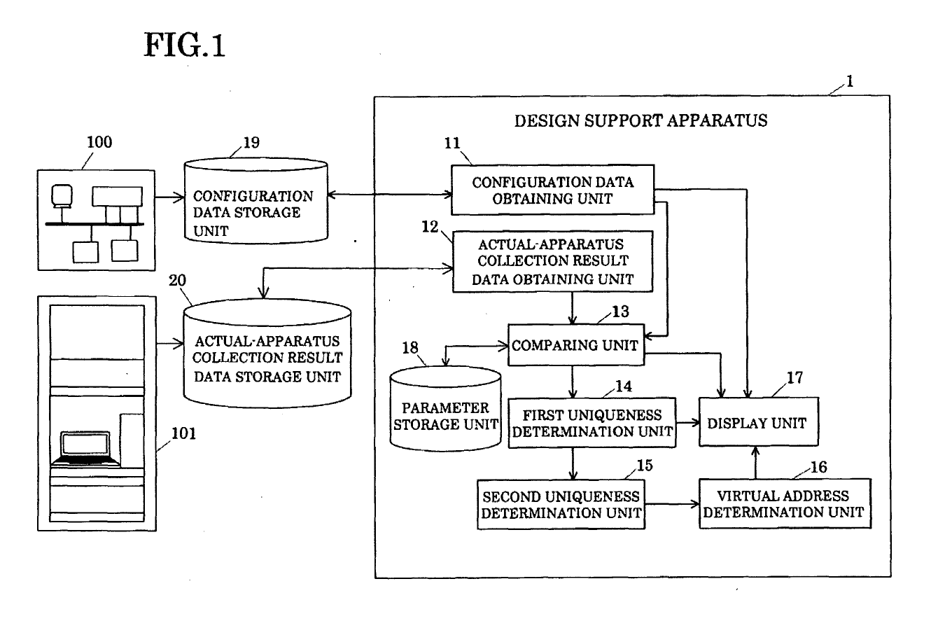

The present embodiments are described below with reference to drawings. FIG. 1 is a diagram showing an example of a structure of a design support apparatus of the present embodiment. A design support apparatus 1 is a processing apparatus comparing the configuration data of a system (for example, a network system) with an actual-apparatus collection result data to determine based on the comparison result whether setting is normally performed to an actual apparatus. For example, the design support apparatus 1 determines whether a network address is normally set to a network apparatus based on the result of comparing the configuration data including a network address of the network apparatus with the actual-apparatus collection result data.

The design support apparatus 1 includes a configuration data obtaining unit 11, an actual-apparatus collection result data obtaining unit 12, a comparing unit 13, a first uniqueness determination unit 14, a second uniqueness determination unit 15, a virtual address determination unit 16, a display unit 17 and a parameter storage unit 18. The configuration data obtaining unit 11 obtains a configuration data of a system (for example, a network configuration data) from a configuration data storage unit 19. The term “configuration data” refers to a data corresponding to a block diagram 100 of the system. The term “network configuration data” refers to, for example, a data for recording (including) a plurality of network apparatuses and network address allocated to each of the network apparatuses. The configuration data storage unit 19 stores the configuration data in advance.

The actual-apparatus collection result data obtaining unit 12 obtains an actual-apparatus collection result data from an actual-apparatus collection result data storage unit 20. The term “actual-apparatus collection result data” refers to a data related to the actual apparatus 101 of a system and includes, for example, configuration information, attributive information and setting information of the actual apparatus 101. In the present embodiment, the actual-apparatus collection result data is collected in advance from network environment constructed based on the network configuration data. Actual-apparatus collection result data is previously stored in the actual-apparatus collection result data storage unit 20.

The comparing unit 13 compares the configuration data of the system with the actual-apparatus collection result data with respect to the same system to determine whether the configuration data of the system coincides with the actual-apparatus collection result data. When the comparing unit 13 determines that the configuration data of the system coincides with the actual-apparatus collection result data, the comparing unit 13 determines that setting is normally performed to the actual apparatus 101 of the system. For example, the comparing unit 13 compares the network address in the network configuration data corresponding to a network apparatus with the network address in the actual-apparatus collection result data corresponding to the network apparatus, when both of the network addresses coincide with each other, the comparing unit 13 determines that the network address is normally set to the network apparatus. When the network address in the network configuration data corresponding to the network apparatus does not coincide with the network address in the actual-apparatus collection result data corresponding to the network apparatus, the comparing unit 13 determines that the network address is abnormally set to the network apparatus. Incidentally, when the configuration data of the system does not coincide with the actual-apparatus collection result data, the comparing unit 13 may determine whether setting is normally performed to the actual apparatus 101 of the system using a determination parameter stored in advance in the parameter storage unit 18. The determination parameter is a parameter for determining whether setting is normally performed to the actual apparatus 101 of the system.

The first uniqueness determination unit 14 determines whether the network address in the actual-apparatus collection result data corresponding to the network apparatus is unique in the actual-apparatus collection result data when the comparing unit 13 determines that the network address in the network configuration data corresponding to the network apparatus does not coincide with the network address in the actual-apparatus collection result data corresponding to the network apparatus. In other words, the first uniqueness determination unit 14 determines whether the network address is unique in all networks to which network apparatus included in the actual-apparatus collection result data belong.

When the network address is unique in the actual-apparatus collection result data, the first uniqueness determination unit 14 determines that the network address is normally set to the network apparatus. When the network address is not unique in the actual-apparatus collection result data, the first uniqueness determination unit 14 determines that the network address is abnormally set to the network apparatus.

The second uniqueness determination unit 15 determines whether the network address is unique in the network to which the network apparatus in the actual-apparatus collection result data belong, when the first uniqueness determination unit 14 determines that the network address in the actual-apparatus collection result data corresponding to the network apparatus is not unique in the actual-apparatus collection result data. The network to which the network apparatus in the actual-apparatus collection result data belong is a subnet obtained based on, for example, the actual-apparatus collection result data. The second uniqueness determination unit 15 determines that the network address is normally set to the network apparatus when the network address is unique in the network to which the network apparatus belong. The second uniqueness determination unit 15 determines that the network address is abnormally set to the network apparatus if the network address is not unique in the network to which the network apparatus belong.

The virtual address determination unit 16 determines whether the network address is a virtual address when the second uniqueness determination unit 15 determines that the network address is not unique in the network to which the network apparatus belongs. When the network address is a virtual address, the virtual address determination unit 16 determines that the network address is normally set to the network apparatus. When the network address is not a virtual address, the virtual address determination unit 16 determines that the network address is abnormally set to the network apparatus.

The display unit 17 displays the results determined by the comparing unit 13, the first uniqueness determination unit 14, the second uniqueness determination unit 15 and the virtual address determination unit 16. The display unit 17 may correct the configuration data based on the result determined by the comparing unit 13 so that the configuration data coincides with the actual-apparatus collection result data and display the corrected result. A determination parameter is stored in advance in the parameter storage unit 18.

The functions of the design support apparatus 1 and the processing units of the design support apparatus 1 are realized by a CPU and a program executed thereon. The program realizing the design support apparatus 1 can be stored in, for example, a computer-readable recording medium, such as semiconductor memory, hard disk, CD-ROM and DVD and is provided with the program recorded in these recording media or provided by transmission and reception using a network through a communication interface.

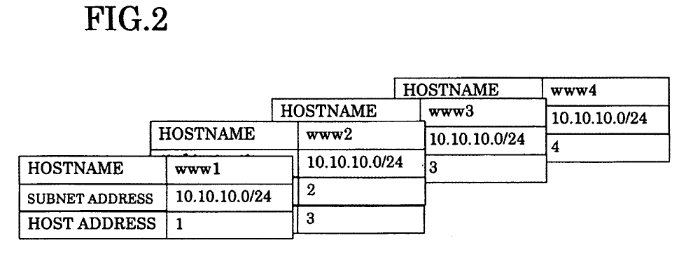

A first embodiment of the present invention is described below with reference to FIGS. 2 to 6. FIG. 2 is a diagram showing an example of a configuration data. FIG. 2 illustrates a network configuration data as an example of the configuration data. The network configuration data illustrated in FIG. 2 includes a hostname indicating each network apparatus and a subnet and a host address which are associated with the hostname.

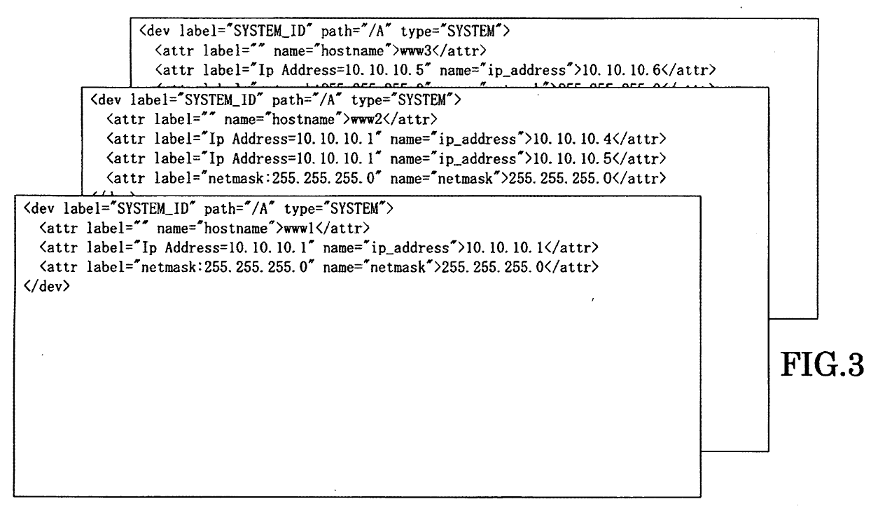

FIG. 3 is a diagram showing an example of an actual-apparatus collection result data. The actual-apparatus collection result data shown in FIG. 3 includes a host name (“hostname”) indicating each network apparatus, an IP address (“ip_address”) and a net mask (“netmask”) that are associated with the hostname. The actual-apparatus collection result data may include information (not shown in FIG. 3) indicating whether the IP address associated with the hostname is a virtual address.

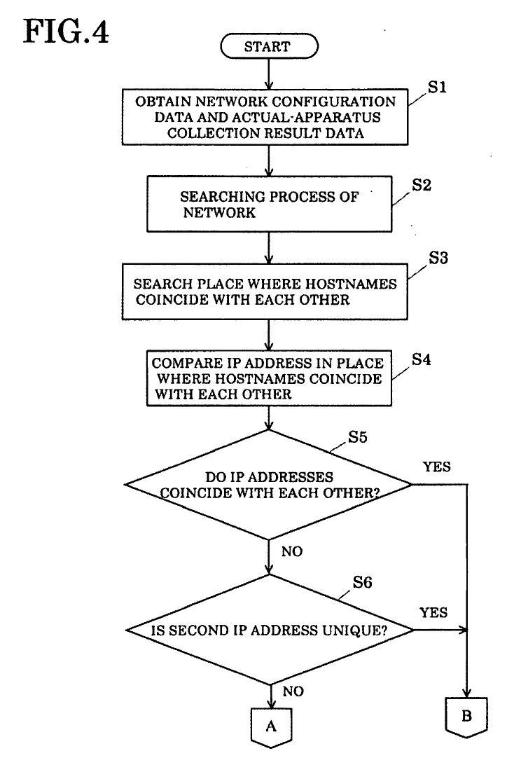

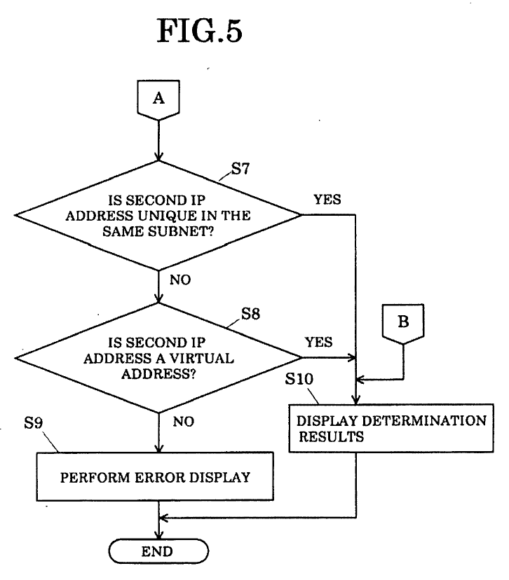

FIGS. 4 and 5 show flow chart of a design support process in the first embodiment of the present invention. At step S1 in FIG. 4, the configuration data obtaining unit 11 reads and obtains the network configuration data from the configuration data storage unit 19. The actual-apparatus collection result data obtaining unit 12 reads and obtains the actual-apparatus collection result data from the actual-apparatus collection result data storage unit 20 (step S1). The comparing unit 13 executes a searching process of a network (step S2). Specifically, in the step S2, the comparing unit 13 calculates a subnet address to which each network apparatus belongs based on actual-apparatus collection result data shown in FIG. 3. That is, the comparing unit 13 obtains a subnet to which each network apparatus belongs. More specifically, the comparing unit 13 calculates a subnet address (10. 10. 10. 0/24) based on “ip_address” and “netmask” indicated by the actual-apparatus collection result data corresponding to the network apparatus whose hostname is “www1,” for example, in FIG. 3. The comparing unit 13 groups the network apparatus in the actual-apparatus collection result data which belong to the same subnet.

Then, the comparing unit 13 searches a place where the hostname in the network configuration data coincides with the hostname in the actual-apparatus collection result data (step S3). Specifically, the comparing unit 13 identifies the network configuration data corresponding to a network apparatus indicated by a hostname and the actual-apparatus collection result data corresponding to the network apparatus. Next, the comparing unit 13 compares the IP address in a place where the hostname in the network configuration data coincides with the hostname in the actual-apparatus collection result data (step S4). Specifically, the comparing unit 13 calculates the IP address (a first IP address) of the network apparatus to which the network configuration data corresponds based on the network configuration data identified by search process in the step S3.

The comparing unit 13 calculates the first IP address (10. 10. 10. 1/24) of the network apparatus based on the subnet address and the host address indicated by the network configuration data corresponding to the network apparatus whose hostname is “www1,” for example, in FIG. 2.

The comparing unit 13 calculates the IP address (a second IP address) set to the network apparatus (actual apparatus) corresponding to the actual-apparatus collection result data based on the actual-apparatus collection result data identified by the search process in the step S3. The comparing unit 13 calculates the second IP address (10. 10. 10. 1/24) set to the network apparatus based on “ip_address” indicated by the actual-apparatus collection result data corresponding to the network apparatus whose hostname is “www1,” for example, in FIG. 3. The comparing unit 13 compares the second IP address with the first IP address.

Then, the comparing unit 13 determines whether the second IP address coincides with the first IP address (step S5). When the comparing unit 13 determines that the second IP address coincides with the first IP address, the comparing unit 13 determines that the second IP address is normally set to the network apparatus. Then, the process proceeds to step S10 in FIG. 5, and the display unit 17 displays the results determined by the comparing unit 13 (step S10). In the step S5 in FIG. 4, when the comparing unit 13 determines that the second IP address does not coincide with the first IP address, the comparing unit 13 determines that the second IP address is abnormally set to the network apparatus, and the process proceeds to step S6.

In the step S6, the first uniqueness determination unit 14 determines whether the second IP address determined not to coincide with the first IP address in the step S5 is unique in the actual-apparatus collection result data (step S6). In the step S6, the first uniqueness determination unit 14 searches IP addresses of the network apparatus belonging to each subnet obtained at step S2 to determine whether the IP address being the same as the second IP address exists in a subnet. If the IP address which is the same as the second IP address exists in a subnet, the first uniqueness determination unit 14 determines that the second IP address is not unique (namely, that the second IP address is abnormally set to the network apparatus) and the process proceeds to step S7 in FIG. 5.

When the IP address being the same as the second IP address does not exist throughout all the subnets, the first uniqueness determination unit 14 determines that the second IP address is unique (namely, that the second IP address is normally set to the network apparatus) and the process proceeds to the step S10 in FIG. 5. In the step S10 in FIG. 5, the display unit 17 displays the result determined by the first uniqueness determination unit 14 (step S10).

In the step S7 in FIG. 5, the second uniqueness determination unit 15 determines whether the second IP address determined not to be unique in the step S6 is unique in the subnet being the same as the subnet to which the network apparatus with the second IP address belong (step S7). Specifically, the second uniqueness determination unit 15 determines whether the IP address being the same as the second IP address exists in the subnet to which the network apparatus with the second IP address belong. When the IP address being the same as the second IP address does not exist in the subnet to which the network apparatus with the second IP address belong, the second uniqueness determination unit 15 determines that the second IP address is unique (namely, that the second IP address is normally set to the network apparatus) and the process proceeds to step S10. In the step S10, the display unit 17 displays the result determined by the second uniqueness determination unit 15.

When the IP address being the same as the second IP address exists in the subnet to which the network apparatus with the second IP address belong, the second uniqueness determination unit 15 determines that the second IP address is not unique (namely, that the second IP address is abnormally set to the network apparatus) and the process proceeds to step S8.

Next, the virtual address determination unit 16 determines whether the second IP address determined not to be unique in the step S7 is a virtual address (step S8). Specifically, the virtual address determination unit 16 refers to information (not shown in a diagram) included in the actual-apparatus collection result data indicating whether the IP address is a virtual address to determine whether the second IP address is a virtual address. When the second IP address is a virtual address, the virtual address determination unit 16 determines that the second IP address is normally set and the process proceeds to the step S10. In the step S10, the display unit 17 displays the result determined by the virtual address determination unit 16.

When the second IP address is not a virtual address, the virtual address determination unit 16 determines that the second IP address is abnormally set and the process proceeds to step S9. In the step S9, the display unit 17 performs an error display indicating that the second IP address is abnormally set (step S9) and the process ends.

Incidentally, in the step S6 in FIG. 4 and in the step S7 in FIG. 5, when the second IP address is determined to be unique, the display unit 17 may change the first IP address in the network configuration data to the second IP address to correct the network configuration data and display the corrected data. The display unit 17 displays the result of the corrected network configuration data to urge the user of the design support apparatus 1 to correct the corrected network configuration data.

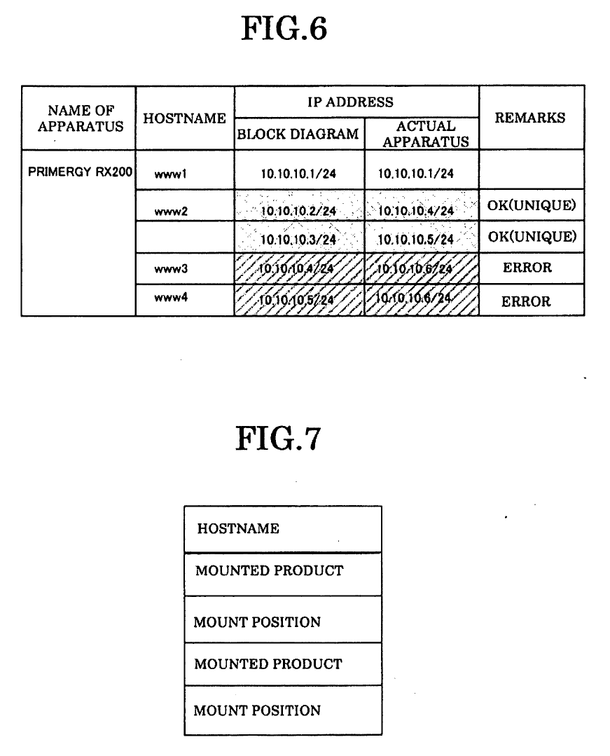

FIG. 6 is a diagram showing an example displayed by the display unit in the first embodiment of the present invention. In FIG. 6, the first IP address and the second IP address corresponding to a hostname indicating each network apparatus forming an apparatus whose name is “PEIMERGY PX200” is displayed. The IP address set to the item of a block diagram in FIG. 6 is the IP address (the first IP address) of the network apparatus in the network configuration data. The IP address set to the item of the actual apparatus is the IP address (the second IP address) set to the network apparatus (the actual apparatus). Information set to the item of remarks is the information indicating whether the second IP address is normally set. For example, “OK” indicates that the second IP address is normally set. “Error” indicates that the second IP address is abnormally set. Furthermore, “OK (unique)” indicates that the first IP address does not coincide with the second IP address but the second IP address is unique, so that the second IP address is normally set.

The display unit 17 may display each determination result with different colors or tints according to the content of results determined by the comparing unit 13, the first uniqueness determination unit 14, the second uniqueness determination unit 15 and the virtual address determination unit 16. The display unit 17 displaying results determined by the comparing unit 13, the first uniqueness determination unit 14, the second uniqueness determination unit 15 and the virtual address determination unit 16 enables the user of the design support apparatus 1 to recognize differences between the network configuration data and the actual-apparatus collection result data and whether the second IP address is abnormally set.

A second embodiment of the present invention is described below with reference to FIGS. 7 to 11. FIG. 7 is a diagram showing an example of a configuration data. The configuration data shown in FIG. 7 includes a hostname indicating apparatus (for example, network apparatus) forming a system, products mounted on the apparatus (for example, a CPU, memory and the like) and mount position indicating a position where the products are mounted (for example, the slot numbers of slots corresponding to a CPU and a memory). The item of mounted products stores information on the name of the mounted product and the performance of the mounted product. For example, when the mounted product is a CPU, the performance of the mounted product is a clock frequency. When the mounted product is a memory, the performance of the mounted product is a capacity.

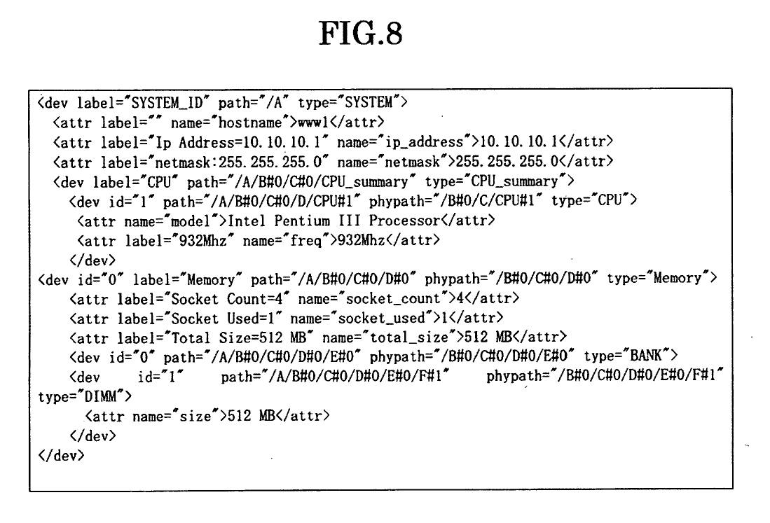

FIG. 8 is a diagram showing an example of an actual-apparatus collection result data. The actual-apparatus collection result data includes, for example, a host name (“hostname”) indicating each network apparatus, and an IP address (“ip_address”) and a net mask (“netmask”) which are associated with the hostname, products mounted on the network apparatus (for example, a CPU (Intel Pentium (registered trademark) III processor), memory and the like), information indicating a position where each product is mounted and performance level of each mounted product (for example, a CPU clock frequency of 932 Mhz and a memory capacity of 512 MB). For a position where the product is mounted, for example, id=“1” in FIG. 8 indicates that the mounted product (for example, a memory) is mounted on a slot of a slot number 1.

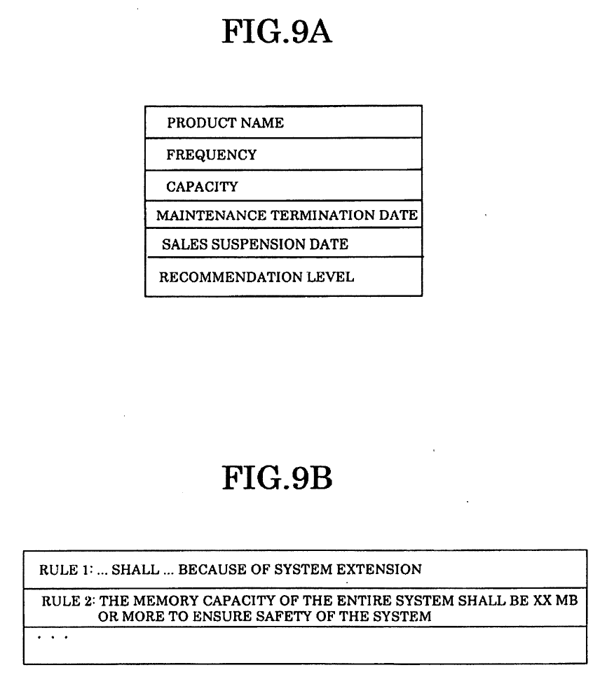

FIGS. 9A and 9B are diagrams showing examples of determination parameters stored in a determination parameter storage unit. FIG. 9A illustrates a product information parameter as an example of the determination parameter. FIG. 9B illustrates an operational rule parameter as an example of the determination parameter.

The product information parameter shown in FIG. 9A includes a product name, clock frequency of a product indicated by the product name, capacity, maintenance termination date, sales suspension date and recommendation level (of a clock frequency and capacity). The operational rule parameter shown in FIG. 9B is a parameter indicating a rule related to the operation of a system, for example. For example, a parameter indicating an operational rule that “the memory capacity of the entire system shall be xx MB or more to ensure the safety of the system” is set in advance as the operational rule parameter.

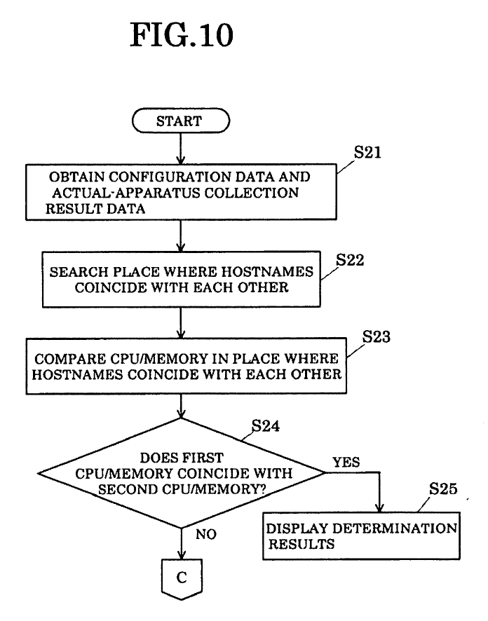

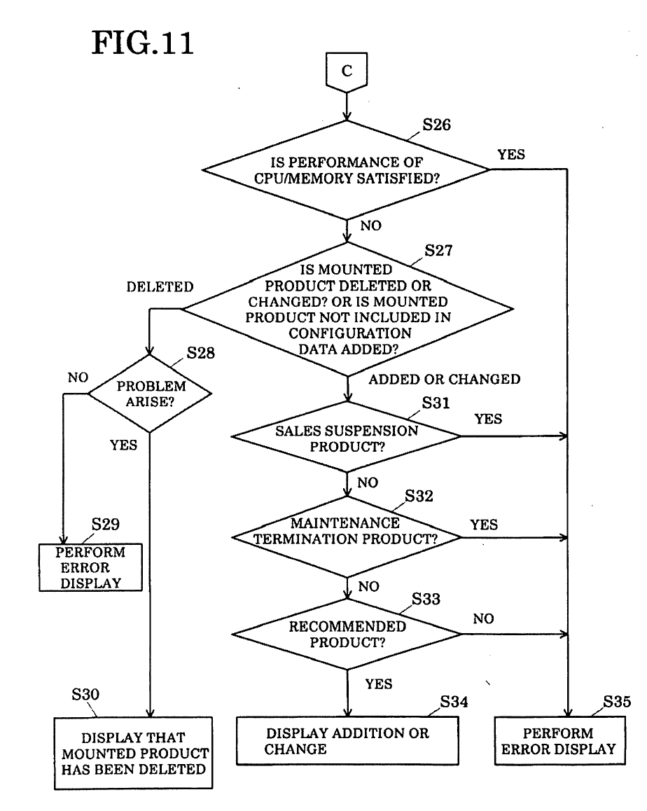

FIGS. 10 and 11 show flow chart of a design support process in the second embodiment of the present invention. At step S21 in FIG. 10, the configuration data obtaining unit 11 reads and obtains a configuration data from the configuration data storage unit 19, and the actual-apparatus collection result data obtaining unit 12 reads and obtains an actual-apparatus collection result data from an actual-apparatus collection result data storage unit 20 (step S21). Next, the comparing unit 13 searches a place where the hostname in the configuration data coincides with the hostname in the actual-apparatus collection result data (step S22). Specifically, the comparing unit 13 identifies the configuration data corresponding to a network apparatus indicated by a hostname and the actual-apparatus collection result data corresponding to the network apparatus.

The comparing unit 13 compares a CPU/a memory in a place where the hostname in the configuration data coincides with the hostname in the actual-apparatus collection result data (step S23). Specifically, the comparing unit 13 compares the CPU/the memory (a first CPU/memory) included in the configuration data identified at step S22 and the CPU/the memory (a second CPU/memory) mounted on the same position as the first CPU/memory, out of the CPUs/the memories included in the identified actual-apparatus collection result data.

The comparing unit 13 determines whether the first CPU/memory coincides with the second CPU/memory (step S24). Specifically, the comparing unit 13 determines whether a CPU (a first CPU) included in the configuration data identified in the step S22 coincides with a CPU (a second CPU) included in the actual-apparatus collection result data and determines whether a memory (a first memory) included in the configuration data coincides with a memory (a second memory) included in the actual-apparatus collection result data.

When the comparing unit 13 determines that the first CPU/memory coincides with the second CPU/memory, the display unit 17 displays the determination result (step S25). When the comparing unit 13 determines that the first CPU/memory does not coincide with the second CPU/memory, the process proceeds to step S26 in FIG. 11.

In the step S26 in FIG. 11, the comparing unit 13 determines whether the performance (clock frequency/capacity) of the second CPU/memory satisfies the performance (clock frequency/capacity) of the first CPU/memory by referring to the actual-apparatus collection result data and the configuration data identified in the step S22 (step S26). When the comparing unit 13 determines that the performance of the second CPU/memory does not satisfy the performance of the first CPU/memory, the display unit 17 performs an error display (step S35). When the comparing unit 13 determines that the performance of the second CPU/memory satisfies the performance of the first CPU/memory, the comparing unit 13 determines whether a mounted product in the configuration data is deleted or changed, or a mounted product not included in the configuration data is added in the actual-apparatus collection result data (step S27).

When the comparing unit 13 determines that the mounted product in the configuration data is deleted, the comparing unit 13 determines whether no problem arises if the mounted product is deleted (step S28). Specifically, the comparing unit 13 obtains information as to a memory capacity required as the entire system by referring to an operational rule parameter indicating an operational rule that “the memory capacity of the entire system shall be xx MB or more to ensure the safety of the system” in the parameter storage unit 18, for example. In addition, the comparing unit 13 obtains the memory capacity of the entire system after the mounted product has been deleted based on the actual-apparatus collection result data. The comparing unit 13 determines whether the memory capacity of the entire system obtained after the mounted product has been deleted satisfies the memory capacity required as the entire system. When the memory capacity of the entire system obtained after the mounted product has been deleted does not satisfy the memory capacity required as the entire system, the comparing unit 13 determines that a problem arises if the mounted product is deleted, and the display unit 17 performs an error display (step S29). When the memory capacity of the entire system obtained after the mounted product has been deleted satisfies the memory capacity required as the entire system, the comparing unit 13 determines that no problem arises if the mounted product is deleted, the display unit 17 displays that the mounted product has been deleted (step S30).

When the comparing unit 13 determines that the mounted product in the configuration data has been changed or a mounted product not included in the configuration data has been added, the comparing unit 13 determines whether the added/changed mounted product is a sales suspension product by referring to a sales suspension date in the product information parameter corresponding to the added/changed mounted product, for example (step S31). When the comparing unit 13 determines that the added/changed mounted product is a sales suspension product, the process proceeds to step S35. When the comparing unit 13 determines that the added/changed mounted product is not a sales suspension product, the comparing unit 13 determines whether the added/changed mounted product is a maintenance termination product by referring to a maintenance termination date in the product information parameter, for example (step S32).

When the comparing unit 13 determines that the added/changed mounted product is a maintenance termination product, the process proceeds to step S35. When the comparing unit 13 determines that the added/changed mounted product is not a maintenance termination product, the comparing unit 13 determines whether the added/changed mounted product is a recommended product by referring to a recommendation level in the product information parameter, for example (step S33). Specifically, the comparing unit 13 determines whether the performance level of the mounted product in the actual-apparatus collection result data satisfies the recommendation level in the product information parameter. When the comparing unit 13 determines that the performance level of the mounted product in the actual-apparatus collection result data satisfies the recommendation level in the product information parameter, the comparing unit 13 determines that the added/changed mounted product is a recommended product and the process proceeds to step S34. When the comparing unit 13 determines that the performance level of the mounted product in the actual-apparatus collection result data does not satisfy the recommendation level in the product information parameter, the comparing unit 13 determines that the added/changed mounted product is not a recommended product and the process proceeds to the step S35.

In the step S34, the display unit 17 displays that the mounted product in the configuration data has been changed and a mounted product not included in the mounted product in the configuration data has been added in the actual-apparatus collection result data (step S34).

In step S27, for example, the comparing unit 13 may determine whether the mounted product in the configuration data is changed only in a mount position. When the mounted product is changed only in a mount position, the process may proceed to the step S34 instead of proceeding to the steps S31 to S33.

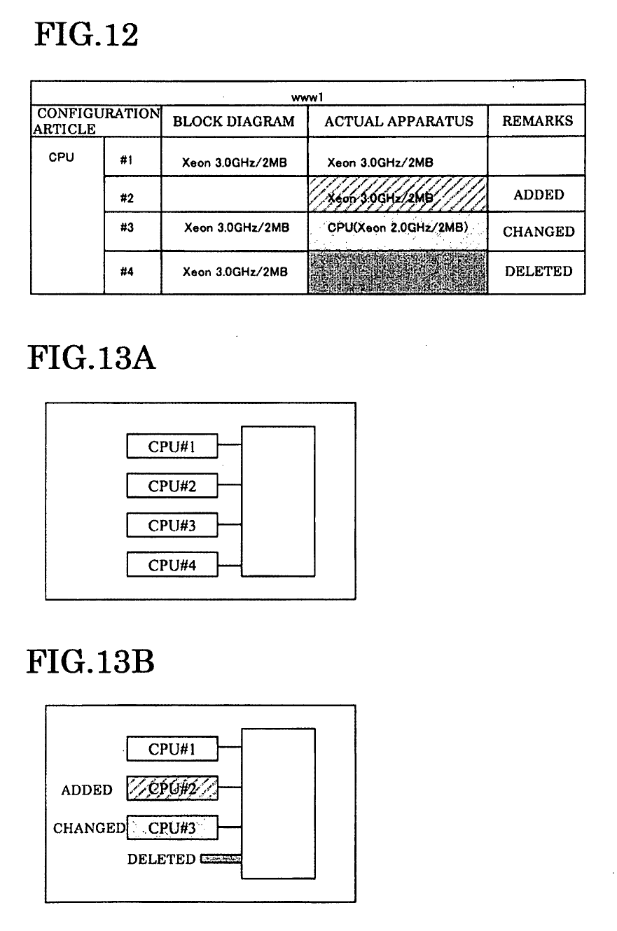

FIG. 12 is a table showing an example displayed by the display unit in the second embodiment of the present invention. Information set to the item of the block diagram in FIG. 12 indicates the CPU (the first CPU) included in the configuration data. Information set to the item of the actual apparatus indicates the CPU (the second CPU) included in the actual-apparatus collection result data. Suppose, for example, that out of three CPUs of CPUs #1, #3 and #4 in the configuration data corresponding to the hostname in the actual-apparatus collection result data corresponding to the hostname “www1”, the CPU #3 is changed (from Xeon 3.0 GHz/2 MB to Xeon 2.0 GHz/2 MB) and the CPU #4 is deleted. Furthermore, suppose that the CPU #2 not included in the configuration data is newly added in the actual-apparatus collection result data. The display unit 17 displays that the CPU #2 is newly added, the CPU #3 is changed and the CPU #4 is deleted in the actual-apparatus collection result data with different display forms (or different colors or tints), as shown in FIG. 12.

The display unit 17 may correct the configuration data so that the configuration data coincides with the actual-apparatus collection result data, create a block diagram (a corrected block diagram) based on the corrected configuration data, and display the created corrected block diagram along with information indicating where of the data has been corrected on a screen. FIG. 13A is a block diagram (a block diagram to be corrected) corresponding to the configuration data to be corrected. FIG. 13B is a corrected block diagram. It can be seen from the corrected block diagram in FIG. 13B that the CPU #4 shown in the block diagram to be corrected in FIG. 13A has been deleted in the corrected block diagram. It is also clear that the CPUs #2 and #3 indicated in the block diagram to be corrected in FIG. 13A have been added and changed respectively in the corrected block diagram.

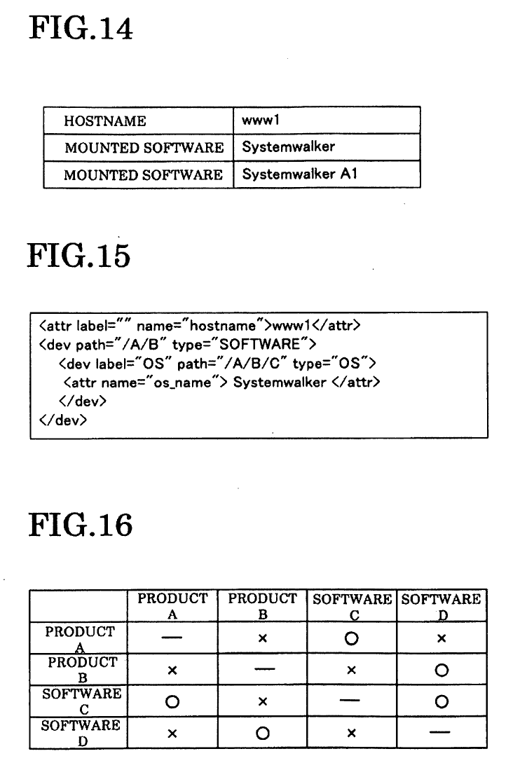

A third embodiment of the present invention is described below with reference to FIGS. 14 to 19. FIG. 14 is a diagram showing an example of a configuration data. The configuration data shown in FIG. 14 includes a hostname indicating a network apparatus forming a system and information on a software (mounted software) mounted on the network apparatus indicated by the hostname.

FIG. 15 is a diagram showing an example of the actual-apparatus collection result data. The actual-apparatus collection result data includes, for example, a host name (“hostname”) indicating a network apparatus and information on a software mounted on the network apparatus indicated by the hostname (for example, a software name of “Systemwalker”).

FIG. 16 is a diagram showing an example of determination parameters stored in the determination parameter storage unit. FIG. 16 shows, as an example, a dependence parameter on software and products. The dependence parameter on software and products include information as to whether a product (for example, a network apparatus) adapts to software (whether the software operates in the product) and the pieces of software are compatible in the same product (for example, whether both the software normally operate in the same product).

For example, in FIG. 16, a circle drawn in the position of cell where the column corresponding to a product A intersects with the row corresponding to a software C indicates that the product A adapts to the software C. An X drawn in the position where the column corresponding to a product A intersects with the row corresponding to a software D indicates that the product A does not adapt to the software D. In addition, an X drawn in the position of cell where the column corresponding to the software C intersects with the row corresponding to a software D indicates that the software C and the software D are not compatible.

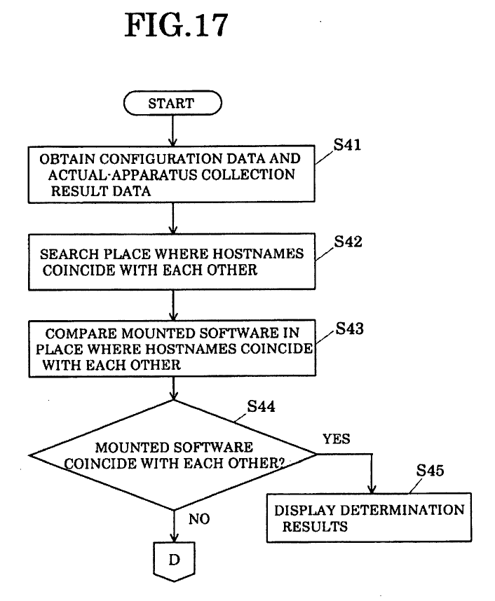

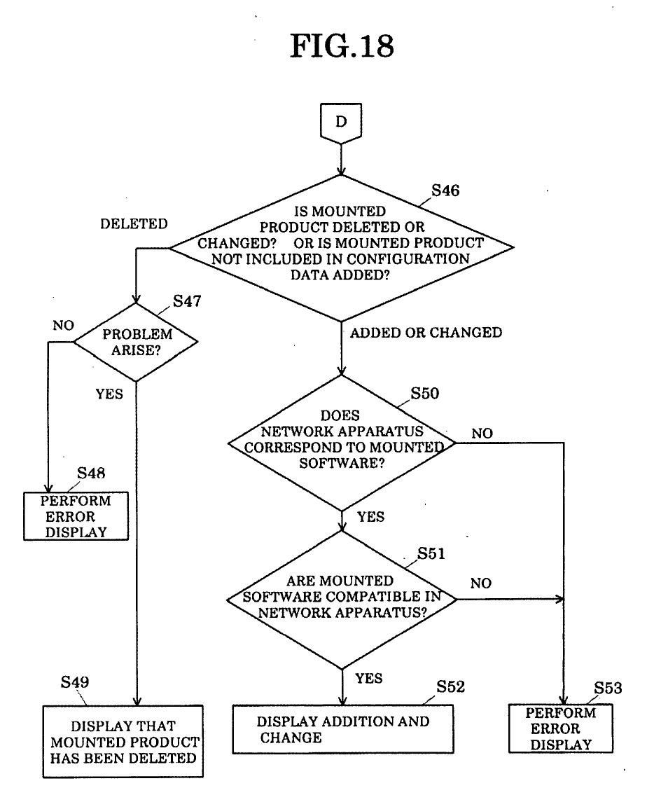

FIGS. 17 and 18 show flow chart of design support process in a third embodiment of the present invention. In step S41 in FIG. 17, the configuration data obtaining unit 11 reads and obtains the configuration data from the configuration data storage unit 19. The actual-apparatus collection result data obtaining unit 12 reads and obtains the actual-apparatus collection result data from the actual-apparatus collection result data storage unit 20 (step S41). Next, the comparing unit 13 searches a place where the hostname in configuration data coincides with the hostname in the actual-apparatus collection result data (step S42). Specifically, the comparing unit 13 identifies the configuration data corresponding to a network apparatus indicated by a hostname and the actual-apparatus collection result data corresponding to the network apparatus.

Then, the comparing unit 13 compares the mounted software in the place where the hostname in the configuration data coincides with the hostname in the actual-apparatus collection result data (step S43). Specifically, the comparing unit 13 compares the mounted software included in the configuration data identified in the step S42 with the mounted software included in the actual-apparatus collection result data identified in the step S42.

The comparing unit 13 determines whether the mounted software included in the configuration data coincides with the mounted software included in the actual-apparatus collection result data (step S44). When the comparing unit 13 determines that the mounted software included in the configuration data coincides with the mounted software included in the actual-apparatus collection result data, the display unit 17 displays the determination result (step S45). When the comparing unit 13 determines that the mounted software included in the configuration data does not coincide with the mounted software included in the actual-apparatus collection result data, the process proceeds to step S46 in FIG. 18.

In the step S46 in FIG. 18, the comparing unit 13 determines whether a mounted software of the configuration data is deleted or changed, or a mounted software not included in the configuration data is added in the actual-apparatus collection result data (step S46). The change of the software means that the version and option of the mounted software and a software house are changed.

When the comparing unit 13 determines that the mounted software in the configuration data has been deleted, the comparing unit 13 determines whether no problem arises if the mounted software is deleted (step S47). Specifically, the comparing unit 13 determines whether the deleted software corresponds to the software (namely, a predetermined essential software) that causes a problem if the software is deleted. When the deleted software corresponds to the predetermined essential software, the comparing unit 13 determines that a problem arises if the mounted software is deleted, and the display unit 17 performs an error display (step S48). When the deleted software does not correspond to the predetermined essential software, the comparing unit 13 determines that no problem arises if the mounted software is deleted, and the display unit 17 displays that the mounted software has been deleted (step S49).

In the step S46, when the comparing unit 13 determines that the mounted software in the configuration data has been changed or a mounted software not included in the configuration data has been added in the actual-apparatus collection result data, the comparing unit 13 determines whether the network apparatus corresponding to the actual-apparatus collection result data corresponds to the changed or added mounted software by referring to the dependence parameter on software and products shown in FIG. 16, for example (step S50). When the comparing unit 13 determines that the network apparatus does not correspond to the mounted software, the display unit 17 performs an error display (step S53).

When the comparing unit 13 determines that the network apparatus corresponds to the mounted software, the comparing unit 13 determines whether the software (for example, the software C and the software D) mounted on the network apparatus are compatible in the network apparatus by referring to the dependence parameter on software and products shown in FIG. 16 (step S51). When the comparing unit 13 determines that the software mounted on the network apparatus are not compatible in the network apparatus, the display unit 17 performs an error display (step S53). When the comparing unit 13 determines that the software mounted on the network apparatus are compatible in the network apparatus, the display unit 17 displays that the mounted software in the configuration data has been changed or a mounted software not included in the configuration data has been added (step S52).

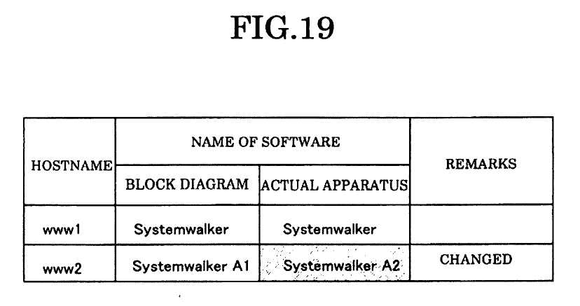

FIG. 19 is a diagram showing an example displayed by the display unit in the third embodiment of the present invention. The hostname in FIG. 19 indicates network apparatus. Information set to the item of the block diagram in FIG. 19 indicates the mounted software included in the configuration data corresponding to the network apparatus. Information set to the item of the actual apparatus indicates the mounted software included in the actual-apparatus collection result data corresponding to the network apparatus. FIG. 19 indicates that the mounted software “Systemwalker A1” in the configuration data has been changed to the mounted software “Systemwalker A2” in the actual-apparatus collection result data corresponding to the hostname “www2”, for example.

As described above, according to the design support apparatus, the design support method and the design support program, a determination can be automatically made as to whether a network address is normally set to a network apparatus, based on the result of comparing the network address in a network configuration data corresponding to the network apparatus with a network address in an actual-apparatus collection result data corresponding to the network apparatus. In addition, a determination can be made as to whether the setting of a network address to the actual apparatus causes a problem in terms of the operation of the actual apparatus, based on the result of determining whether the network address set to the actual network apparatus is unique in an actual-apparatus collection result data.

Furthermore, according to the design support apparatus, the design support method and the design support program, a determination can be made as to whether the setting of a network address to the actual apparatus causes a problem in terms of the operation of the actual apparatus, based on the result of determining whether the network address set to the actual network apparatus is unique in the network being the same as the network to which the network apparatus belongs. Still furthermore, a determination can be made as to whether the setting of a network address to the actual apparatus causes a problem in terms of the operation of the actual apparatus, based on the result of determining whether the network address set to the actual network apparatus is a virtual address.

The turn of the embodiments isn't a showing the superiority and inferiority of the invention. Although the embodiments of the present inventions have been described in detail, it should be understood that the various changes, substitutions, and alterations could be made hereto without departing from the spirit and scope of the invention.

What is claimed is:

1. A design support apparatus, comprising:
a first obtaining unit obtaining a network configuration data in which a plurality of network apparatuses and network address allocated to each of the network apparatuses are recorded;
a second obtaining unit obtaining an actual-apparatus collection result data collected from network environment constructed based on the network configuration data;
a comparing unit comparing a network address in the network configuration data corresponding to a network apparatus with a network address in the actual-apparatus collection result data corresponding to the network apparatus, and determining that the network address is normally set to the network apparatus when the network address in the network configuration data coincides with the network address in the actual-apparatus collection result data; and
a first uniqueness determination unit determining, when the comparing unit determines that the network address in the network configuration data corresponding to the network apparatus does not coincide with the network address in the actual-apparatus collection result data corresponding to the network apparatus, whether the network address in the actual-apparatus collection result data corresponding to the network apparatus is unique in the actual-apparatus collection result data, and determining that the network address is normally set to the network apparatus when the network address is unique in the actual-apparatus collection result data.

2. The design support apparatus according to claim 1, further comprising:
a second uniqueness determination unit determining, when the first uniqueness determination unit determines that the network address is not unique in the actual-apparatus collection result data, whether the network address in the actual-apparatus collection result data corresponding to the network apparatus is unique in a network to which the network apparatus in the actual-apparatus collection result data belongs, and determining that the network address is normally set to the network apparatus when the network address is unique in the network.

3. The design support apparatus according to claim 2, further comprising:
a virtual address determination unit determining, when the second uniqueness determination unit determines that the network address is not unique in the network, whether the network address is a virtual address, and determining that the network address is normally set to the network apparatus when the network address is a virtual address.

4. A design support method, comprising:
a first obtaining step of obtaining a network configuration data in which a plurality of network apparatuses and network address allocated to each of the network apparatuses are recorded;
a second obtaining step of obtaining an actual-apparatus collection result data collected from network environment constructed based on the network configuration data;
a comparing step of comparing a network address in the network configuration data corresponding to a network apparatus with a network address in the actual-apparatus collection result data corresponding to the network apparatus, and determining that the network address is normally set to the network apparatus when the network address in the network configuration data coincides with the network address in the actual-apparatus collection result data; and
a first uniqueness determination step of determining, when the comparing step determines that the network address in the network configuration data corresponding to the network apparatus does not coincide with the network address in the actual-apparatus collection result data corresponding to the network apparatus, whether the network address in the actual-apparatus collection result data corresponding to the network apparatus is unique in the actual-apparatus collection result data, and determining that the network address is normally set to the network apparatus when the network address is unique in the actual-apparatus collection result data.

5. The design support method according to claim 4, further comprising:
a second uniqueness determination step of determining whether the network address in the actual-apparatus collection result data corresponding to the network apparatus is unique in a network to which the network apparatus in the actual-apparatus collection result data belongs when the first uniqueness determination step determines that the network address is not unique in the actual-apparatus collection result data, and determining that the network address is normally set to the network apparatus when the network address is unique in the network.

6. The design support method according to claim 5, further comprising:
a virtual address determination step of determining, when the second uniqueness determination step determines that the network address is not unique in the network, whether the network address is a virtual address, and determining that the network address is normally set to the network apparatus when the network address is a virtual address.

7. A design support program causing a computer to execute:
a first obtaining process of obtaining a network configuration data in which a plurality of network apparatuses and network address allocated to each of the network apparatuses are recorded;
a second obtaining process of obtaining an actual-apparatus collection result data collected from network environment constructed based on the network configuration data;
a comparing process of comparing a network address in the network configuration data corresponding to a network apparatus with a network address in the actual-apparatus collection result data corresponding to the network apparatus, and determining that the network address is normally set to the network apparatus when the network address in the network configuration data coincides with the network address in the actual-apparatus collection result data; and
a first uniqueness determination process of determining whether the network address in the actual-apparatus collection result data corresponding to the network apparatus is unique in the actual-apparatus collection result data when the comparing process determines that the network address in the network configuration data corresponding to the network apparatus does not coincide with the network address in the actual-apparatus collection result data corresponding to the network apparatus, and determining that the network address is normally set to the network apparatus when the network address is unique in the actual-apparatus collection result data.

8. The design support program according to claim 7 causing a computer to execute:
a second uniqueness determination process of determining, when the first uniqueness determination process determines that the network address is not unique in the actual-apparatus collection result data, whether the network address in the actual-apparatus collection result data corresponding to the network apparatus is unique in a network to which the network apparatus in the actual-apparatus collection result data belongs, and determining that the network address is normally set to the network apparatus when the network address is unique in the network.

9. The design support program according to claim 8 causing a computer to execute:
a virtual address determination process of determining, when the second uniqueness determination process determines that the network address is not unique in the network, whether the network address is a virtual address, and determining that the network address is normally set to the network apparatus when the network address is a virtual address.
